(19) United States
(12) Patent Application Publication
(10) Pub. No.: US 2014/0138379 A1
(43) Pub. Date: May 22, 2014

(54) Candle Cap

(71) Applicant: Scott Frank HIll, Duxbury, MA (US)

(72) Inventor: Scott Frank HIll, Duxbury, MA (US)

(21) Appl. No.: 13/665,190

(22) Filed: Oct. 31, 2012

(51) Int. Cl. F21V 35/00; B65D 51/24; B65D 43/02

(52) U.S. Cl. CPC F21V 35/00; B65D 43/02; B65D 51/24; B65D 51/245
USPC 220/212; 428/7; 215/228; 215/229

(57) ABSTRACT

Often times friends would like to buy a special drink or an ice cream soda to celebrate a special occasion such as a birthday, anniversary or graduation event. A candle would be nice, but there is no easy way of mounting a small candle, sparkler or other illuminating device to the beverage glass or bottle along with a congratulatory message to mark the special occasion. This invention also provides a means to conveniently mount a candle or sparkler onto the top of a beverage while also providing restaurants, bars and other establishments and venues to offer a unique service for their customers while also creating a unique method to advertise the establishment, distributors, manufacturer with brand names and branding logos.

Candle Cap, a Custom designed beverage Candle Cap that can be placed over a wide variety of cups, shot glasses, beer bottles, liquor bottles, soda cans, beer cans, ice cream soda and assorted drinking glasses which will hold a candle for special celebrations while also displaying market brands of products and/or business venues.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE, A TABLE OR COMPUTER PROGRAM LISTING COMPACT DISK

Not Applicable

### BACKGROUND OF INVENTION

Not Applicable

### BRIEF SUMMARY OF THE INVENTION

The present invention relates to a Custom designed beverage “Candle Cap” that covers a wide variety of cups, shot glasses, beer bottles, liquor bottles, soda cans, beer cans, ice cream soda's etc. for special celebrations. (ref attached drawings)

The device is comprised of the following:
1. Vacuum formed or pressed “covers” in multiple sizes which fit a variety of cups and glasses
2. Accessory message ring(s) which are fitted to the outside perimeter of the cap.3. Optionally sold with a pack of candles (off the shelf)
Necessary:
   i. 1. The “Candle Cap” cover
   ii. 2. The message ring (i.e. Happy Birthday)
   iii. 3. A candle
   iv. Optional:
   v. 1. Custom branding logo's
   vi. Message rim. This displays a message or logo on the topside of the “candle cup”.

A “cap” with a mount for a candle is placed over a celebratory drink, soda or ice cream glass.

The “cap” comes in multiple sizes to fit a variety of glasses, bottles and cans. The cover protects the beverage from candle wax after it is lit. A special “message” ring fits over the outside perimeter of the cap. Custom on-demand logos can be adhered to the top (and sides) of the “Candle Cap” as advertisements for the establishment, restaurant or bar. Other custom logos or graphics can be used and adhered to the top for non commercial use as well. The caps are extremely low cost which provides a “customer take home” memorabilia branding opportunity.

Vacuum form plastic or press mold.

Standard stamped message rings

Novelty printing services could provide custom message rings or logo's along with distribution channels

If one wanted to purchase a special beverage (or for example ice cream soda) for a special event, he/she would request from the establishment (i.e. restaurant/bar) a “Candle Cap”. When the beverage was delivered, it would have a lit candle on top of the glass to mark the special occasion. The recipient would blow out the candle, remove the cap and enjoy the beverage or ice cream. The recipient, at the establishment's discretion, may be allowed to keep the cap as a memento of the occasion. That same memento would have the establishments name and special message ring as a reminder of the event.

Trade show giveaways, gifts, special table decorations. It does not have to be mounted on a glass. These devices can be positioned on any flat surface. Multiple candles in front of place settings provide a very unique and formal atmosphere.

This invention may consist of very low cost plastic/acrylic or glass “cap” or “cover” which allows the mounting of a small birthday size candle on top. It can be easily positioned over a range of beverage holders to provide that special touch to the celebratory occasion. Additionally, this invention provides another unique opportunity for a restaurant, bar or other establishment to advertise services as well as their respective branding logo. They can be produced at an extremely large volume with low cost to novelty suppliers. In addition to standard cover “rings” such as ‘Happy Birthday” or “Congratulations” messaging, there are endless possibilities for custom on-demand graphics which can be applied over the top of the “Candle Cap” to provide an even more personnel experience. Higher end models can be manufactured with colorful LEDs mounted within clear acrylic material which even further accentuates the occasion. They could be purchased by establishments in large “giveaway” designs (publicity/advertising) or by individuals who simply want to make an event even more special.

To my knowledge, there is no other product which offers this capability. It is simple, low cost and serves a multitude of purposes.

There is no product to my knowledge that allows one to mount or float a candle over a beverage glass with custom messaging and establishment logo branding.

### BRIEF DESCRIPTION OF THE SEVERAL VIEWS OF THE DRAWINGS

FIG. 1 illustrates an exemplary beverage cup in which a cap of the present invention may be affixed.

FIG. 2 illustrates a multi-view of the present invention with the candle holder beneath the surface.

FIG. 3 illustrates the top view of the present invention.

FIG. 4 illustrates the side view of the present invention.

FIG. 5 illustrates the top view of the present invention displaying a sample message.

FIG. 6 illustrates the side view of the present invention displaying a celebratory word “Congratulations”.

FIG. 7 illustrates the bottom view of the present invention.

FIG. 8 illustrates the side view of the present invention with the candle holder above the surface.

FIG. 9 illustrates the top view of the current invention.

FIG. 10 illustrates an exemplary beverage bottle in which a cap of the present invention may be affixed.

FIG. 11 illustrates the side view of the present invention.

FIG. 12 illustrates the top view of the present invention.

FIG. 13 illustrates the multi-view of the present invention.

### DETAILED DESCRIPTION OF THE DRAWINGS

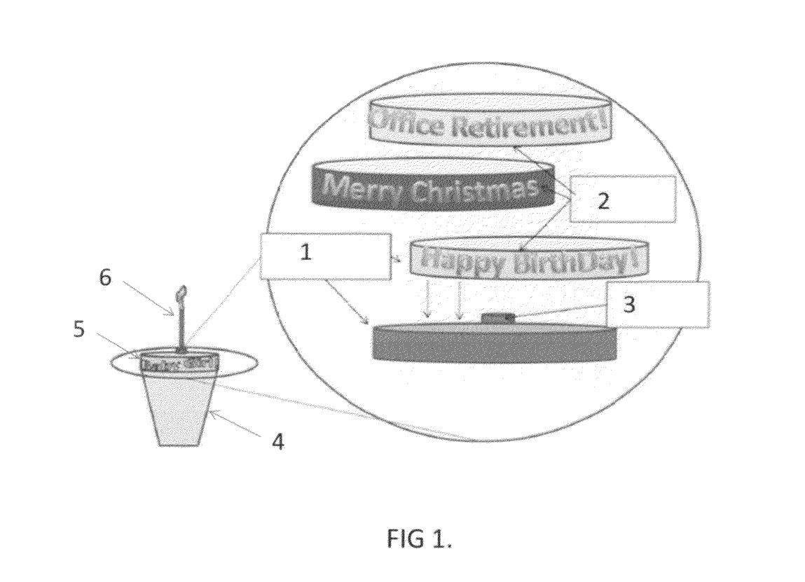

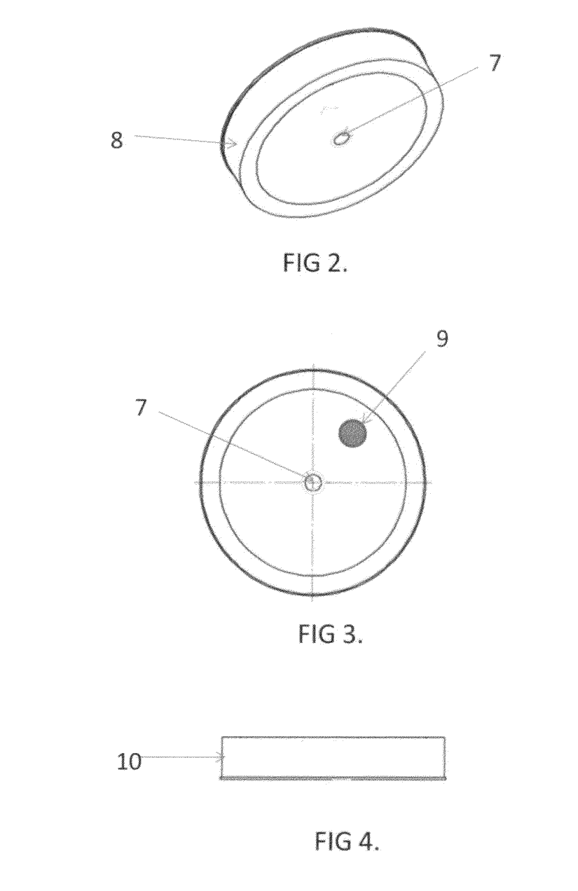

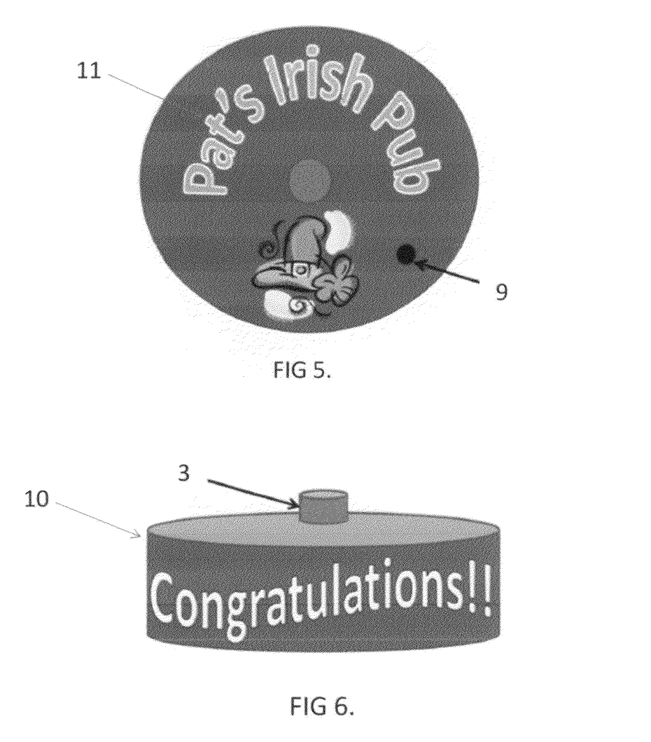

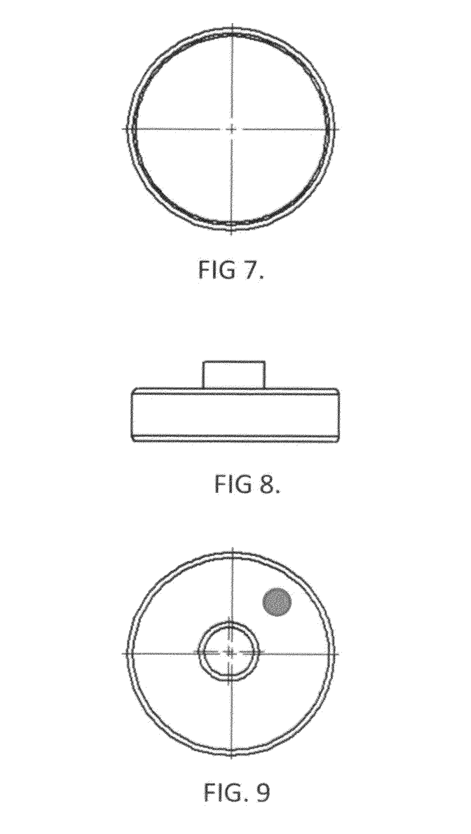

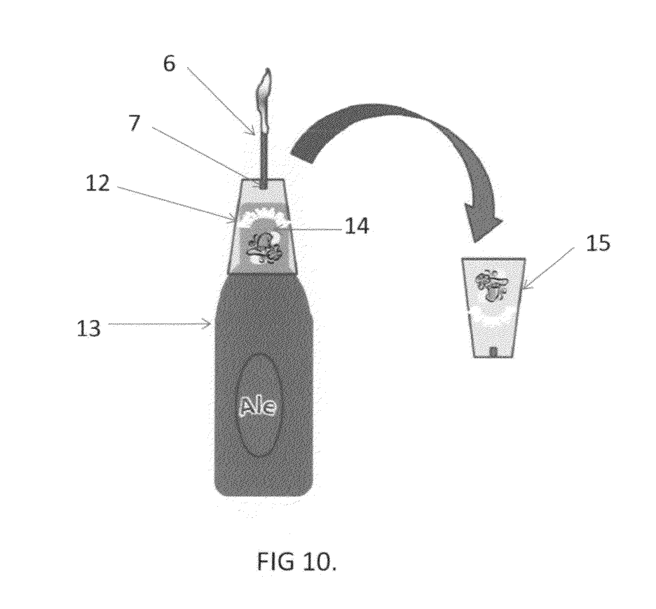

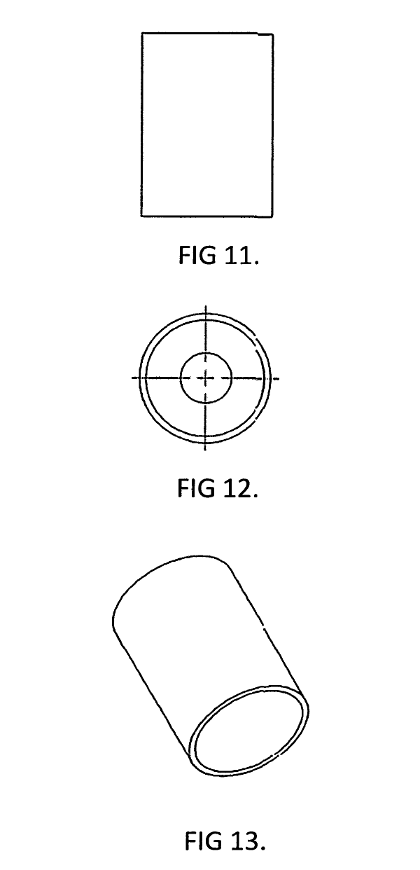

Referring now to the drawings illustrated on pages 13-18, wherein the showings are for the purpose of illustrating the preferred embodiment of the invention only, and not for the purpose of limiting same, FIG. 1, shows a Candle Cap for a drinking glass, cup, bottle, shot glass or other drinking container. The cap is illustrated as cylindrical shaped object and is made from plastic. It should be appreciated that the current invention is not limited to a specific material and that it may be made from other materials such as wood, glass, metal, plastic. The cap 5 fits entirely over the mouth of an average size drinking cup 4. It should be noted that different size Candle Caps are illustrated in FIGS. 5-10 and are designed to fit different types of containers such as a shot glass or beverage bottle. The side of the cap 1 is designed with a small lip to maintain the Candle Cap in place on top of the drinking glass or cup and provides a surface which can contain a marketing or celebratory message. The message is inscribed on a piece of elastic or tight fitting material and slid onto the side of the cap 1. This multipurpose feature enables the user to remove and add different messages to the candle cap without having to use a new cap for each new message. The user may also permanently inscribe a message onto the side of the cap so that it remains forever. The message 2 that is displayed on the side can be, but is not limited to, a congratulatory phrase such as “Happy Birthday” or “Happy Holidays”. As should be appreciated, the cap message could take on many different combinations of alphabet, numeric or alpha-numeric characters “Happy21st”, “Congratulations”, “50^{th}”. All sizes of the Candle Cap are designed with a small mounting hole in the center 3 to support a standard “birthday” type candle size 6 or illuminating item such as a sparkler This small mounting hole 3 (hence forth referred to as “candle holder”), is designed to secure a candle 6 (or such items as a sparkler) in place in an upright position. The candle holder can be above the surface of the cap 3 or it can reside below the surface of the cap 7 illustrated in FIGS. 10 and 7 in FIG. 2. This feature is intended to minimize the amount of liquid displacement (spill or waste) when the Candle Cap is placed on a filled glass such as a shot glass. FIG. 3 illustrates the top view of the candle cap. The Candle Cap is designed with an optional straw opening 9 where the user may install a straw into the hole and then consume the liquid in the cup or glass through it. The hole will be large enough to accompany a variety size of straw sizes. It can be appreciated that the straw hole can be located anywhere on the face of the cap and is not limited in number. The candle holder 7 is shown on the top face of the cap. FIG. 2 shows a multi-view of the current invention. 7 illustrates the candle holder which is below the surface and 8 illustrates the side where a message may be displayed. FIG. 4 illustrates the side of the candle cap 10 where a message can optionally be located. It can be appreciated that the message on the side 10 may or may not be present.

FIG. 5 illustrates the top of the cap where a message 11 is displayed. The message is in a series of letters spelling the words “Pat's Irish Pub”. As should be appreciated, the cap message could be comprised of many different combinations of business logos, trademarks alphabet, numeric or alpha-numeric characters such as “Easy's 16 Pub”, “Brian's Early Retirement”, “Scotts 21 Festival”. A straw may also be inserted into the hole 9 on the face of the cap. FIG. 6 illustrates the side of the cap where 10 is a message that may be present. The candle holder 3 is present on the top face of the Candle Cap.

FIG. 10 illustrates a different size candle cap. This cap 12 fits over the neck of a bottle 13. The message 14 is displayed on the side of the cap and the candle holder 7 resides on the top of the cap which holds the candle 6. This unique cap also has the ability to be removed from the bottle and flipped upside down to use as a small drinking cup 15.

It should be appreciated that the cap is not limited to circular symmetrical shapes and be triangular, rectangular, hexagonal, or any other symmetrical or asymmetrical shape.

1. A custom designed beverage “Candle Cap” that covers a wide variety of cups, shot glasses, beer bottles, liquor bottles, soda cans, beer cans, ice cream soda's etc. for special celebrations.

2. The features and attributes of this invention together create a unique celebration or event novelty by combining a candle or sparkler holder that can be manufactured in a variety of sizes and shapes that can be used for company, personnel or venue and brand messaging.

3. The cap described in claim 1, wherein, in combination with a drinking glass, cup, bottle, shot glass or other drinking container, the cap, comprising:
a. a cylindrical, triangular, rectangular, hexagonal, or any other symmetrical or asymmetrical shape comprising a rigid material;
b. a candle holder on the top face capable of holding a candle, sparkler or
c. a hole on the top face for a straw;
d. an alphabet, numeric or alpha-numeric characters displayed on the side;
e. an alphabet, numeric or alpha-numeric characters displayed on the top face.
